(19) United States
(12) Patent Application Publication
(10) Pub. No.: US 2017/0010915 A1
(43) Pub. Date: Jan. 12, 2017

(54) PERFORMING PROCESSING TASKS USING AN AUXILIARY PROCESSING UNIT

(71) Applicant: HEWLETT PACKARD ENTERPRISE DEVELOPMENT LP, Houston, TX (US)

(72) Inventors: Indrajit ROY, Palo Alto, CA (US); Vanish TALWAR, Palo Alto, CA (US); Pravin Bhanudas SHINDE, Palo Alto, CA (US)

(21) Appl. No.: 15/114,083

(22) PCT Filed: Jan. 31, 2014
(86) PCT No.: PCT/US2014/014253

§ 371 Date: Jul. 26, 2016

(51) Int. Cl. G06F 9/48

(52) U.S. Cl. CPC G06F 9/4881

(57) ABSTRACT

Examples for performing processing tasks using an auxiliary processing unit are described. In an example, a computing system may include a processor to perform a plurality of processing tasks for each of a plurality of applications hosted by the computing system. An auxiliary processing task may be determined for an active application from the plurality of applications. The auxiliary processing tasks may be from among the plurality of processing tasks performed for the active application. Further, the processing code corresponding to the auxiliary processing task may be provided to the auxiliary processing unit of the computing system. The auxiliary processing unit may execute the processing code to perform corresponding auxiliary processing tasks and share a processing load with the processor.

### BACKGROUND

With recent advances in technology, computing devices have become ubiquitous. Individuals and organizations are increasingly dependent on the computing devices to perform various tasks and handle large amounts of data. In a typical scenario, the computing devices may interact with other computing devices over a network. The network often becomes a bottleneck for performance as its speed grows slower than the processing speed of the computing devices. Recent developments have led to substantial enhancements in network speeds, but these enhancements have not yet matched the processing speed of a network computing device.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates an example computing system for performing auxiliary processing tasks;

FIG. 2 illustrates various example components of the computing system of FIG. 1 for performing auxiliary processing tasks;

FIG. 3 schematically illustrates an example architecture of the computing system to perform auxiliary processing tasks;

FIG. 4 is a flowchart for performing processing tasks using an auxiliary processing unit, according to various examples;

FIG. 5 is a flowchart for providing processing codes pertaining to auxiliary processing tasks, according to various examples; and

FIG. 6 illustrates an example computer readable medium storing instructions to perform auxiliary processing tasks.

### DETAILED DESCRIPTION

Certain network based applications often involve multiple processing tasks to be performed on data packets being received, or sent over a network. These processing tasks are performed by a processor of a computing device, which may add to the processing load already being handled and managed by the processor. With recent developments in technology, the speed at which the network provides the data packets often matches or exceeds the speed at which these data packets may be processed by the processor.

Systems and methods for performing auxiliary processing tasks using an auxiliary processing unit are described. An auxiliary processing unit, as generally described herein, refers to a processing unit that supplements another processing unit, such as a processor of a computing system. In an example, certain processing tasks to be performed by the processor may be offloaded to an auxiliary processing unit. The auxiliary processing unit may be implemented on components which enable communication with a network. Examples of such components may include, but are not limited to, a network interface card (NIC) associated with the computing system. The processing tasks offloaded to the auxiliary processing unit, referred to as auxiliary processing tasks, may include routine tasks, which may require considerable processing resources.

In one example, the auxiliary processing tasks for each network based application hosted by the computing system may be predefined. The auxiliary processing tasks may be selected, for example, based on one or more attributes. These attributes may include dependency, parallel execution, and amount of processing resources utilized for execution. Auxiliary processing tasks may include processing tasks that can be expressed as independent tasks or that can be efficiently performed on the auxiliary processing unit as compared to being performed by the processor.

Auxiliary processing tasks may also include processing tasks, which when performed on an auxiliary processing unit provide better processor and application performance than when performed by the processor. For example, in security applications, such as network intrusion detection applications and security event analysis applications, data packets may include application request packets and event log information. In said example, the processing tasks, such as pattern matching, may be offloaded to the auxiliary processing unit. The auxiliary processing unit may perform a pattern match on data packet content and then inform the security application whether the data packet is a security threat. Performing pattern matching in the auxiliary processing unit may improve the application performance and the processor performance. Examples of such processing tasks may include, but are not limited to, data packet routing, checksum calculations, pattern matching, string matching, message digest calculations, data encryption and decryption, and hashing.

In operation, the auxiliary processing tasks pertaining to applications that are currently active may be processed by the auxiliary processing unit. For purposes of explanation, the applications that are currently running on the computing system and require processing resources to facilitate data exchange may be identified as active applications. Further, to offload some of the processing load of the processor, for each of the active applications, one or more auxiliary processing tasks, may be identified. In one example, the auxiliary processing tasks may be identified based on an application-task mapping. Once the auxiliary processing tasks are identified, for each of the identified processing tasks, a corresponding executable processing code for processing the offloaded tasks may be provided to the auxiliary processing unit. In one example, the auxiliary processing unit may install the received processing codes and perform the corresponding auxiliary processing tasks on the data packets pertaining to each of the active applications.

Further, the active application corresponding to each of the installed processing codes may be monitored. Based on monitoring, if it is determined that an application is now inactive or no longer requires one or more of the installed processing codes, the processing codes may be uninstalled from the auxiliary processing unit. In this manner, the auxiliary processing unit may retain processing codes of the auxiliary processing tasks for one or more active applications, and may not include processing codes for the auxiliary tasks performed by all the applications hosted by the computing system. As a result, efficient utilization of processing capabilities of the auxiliary processing unit may be achieved. Further, this may facilitate sharing of the auxiliary processing unit among multiple applications, which may scale up processing performance without having to add more silicon-based or field programmable gate arrays (FPGA) based cores on the auxiliary processing unit.

In another example, one of the auxiliary processing tasks may include data packet routing to an appropriate destination processing unit, such as a processor core amongst multiple processor cores. In such a case, the content of the received data packet may be analyzed, based on core identification rules to identify a corresponding core of the processor. The core identification rules may be provided by way of a processing code, which may be provided to the auxiliary processing unit 106 for data packet routing. The core identification rules may indicate the core to be selected based on content of the data packet. Once the correct core is identified, the data packets are routed to correct destination core. This, in turn reduces the processing toad of the processor. For example, in case of memcached based applications, appropriate routing may avoid complex locking or key forwarding mechanisms, which are processor intensive. Accordingly, the auxiliary processing unit may aid in performing application aware routing, thereby saving on computational time and resources of the processor. Thus, the addition of processing power may also suit a multi-core processor environment.

The above systems and methods are further described in conjunction with figures and associated description below. It should be noted that the description and figures merely illustrate the principles of the present disclosure. It will thus be appreciated that various arrangements that embody the principles of the present disclosure, although not explicitly described or shown herein, can be devised from the description and are included within its scope.

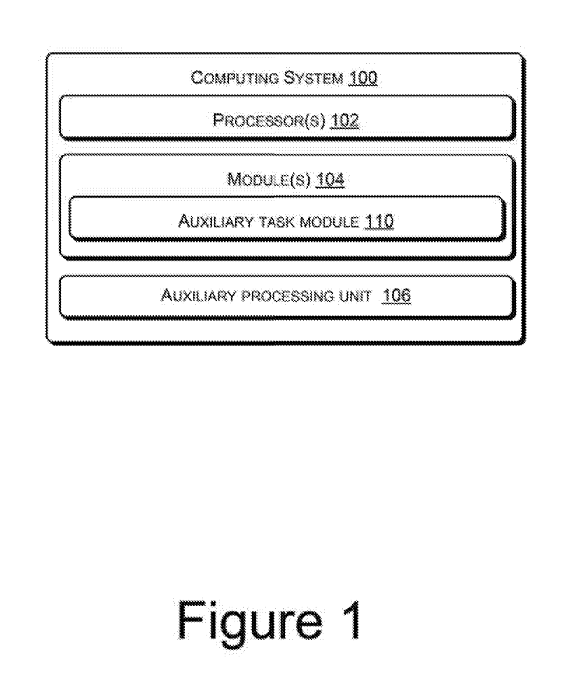

FIG. 1 illustrates various components of en example computing system 100. The computing system 100 may be implemented in, for example, desktop computers, multiprocessor systems, personal digital assistants (PDAs), laptops, network computers, cloud servers, minicomputers, mainframe computers, hand-hew devices, such as mobile phones, smart phones, and touch phones, and tablets. The computing system 100 may also be hosting a plurality of applications.

The computing system 100 may include, for example, a processor 102, modules 104 communicatively coupled to the processor 102, and an auxiliary processing unit 106 communicatively coupled to the processor 102. In an example, the auxiliary processing unit 106 may be provided on a peripheral device, such as a network interface card (NIC). Further, the auxiliary processing unit 106 may be provided, for example, by way of silicon based cores or FPGA-based cores on the NIC.

The processor(s) 102 may include microprocessors, microcomputers, microcontrollers, digital signal processors, central processing units, state machines, logic circuitries and/or any other devices that manipulate signals and data based on computer-readable instructions. Further, functions of the various elements shown in the figures, including any functional blocks labeled as “processor(s)”, may be provided through the use of dedicated hardware as well as hardware capable of executing computer-readable instructions.

The modules 104, amongst other things, include routines, programs, objects, components, and data structures, which perform particular tasks or implement particular abstract data types. The modules 104 may also be implemented as, signal processor(s), state machine(s), logic circuitries, and/or any other device or component that manipulate signals based on operational instructions. Further, the modules 104 can be implemented by hardware, by computer-readable instructions executed by a processing unit, or by a combination thereof.

The modules 104 may include, for instance, an auxiliary task module 110. In an example, each of a plurality of applications hosted by the computing system 100 may be monitored to obtain an activity status of each of the applications. Based on the monitoring, one or more active applications may be identified by the computing system 100. Further, for the active applications, the auxiliary task module 110 may offload certain processing tasks to the auxiliary processing unit 106. The processing tasks that may be offloaded to the auxiliary processing unit 106 may be referred to as the auxiliary processing tasks. The auxiliary processing tasks may involve analysis and/or modification of data packets or data included in the data packets pertaining to the active applications. In an example, the auxiliary processing tasks may rely on incoming or outgoing data packets and may otherwise be self contained.

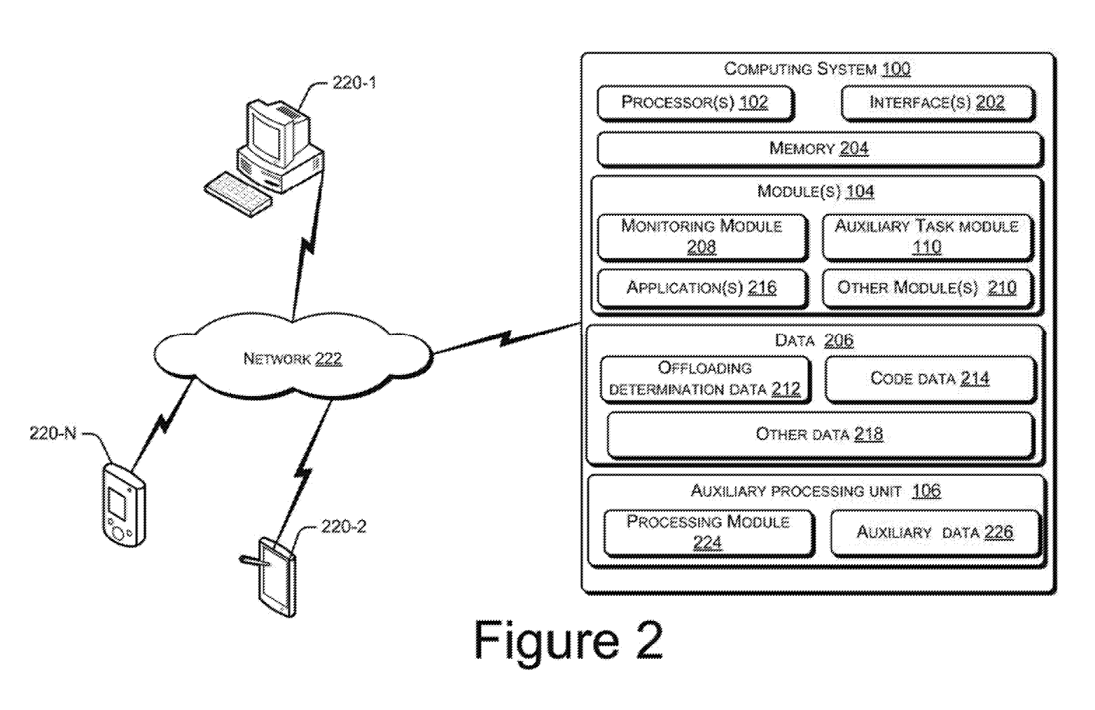

For each of the active applications, the auxiliary task module 110 may identify corresponding auxiliary processing tasks using an application-task mapping, described in more detail herein below. Further, a processing code for each of the identified auxiliary processing tasks may be provided to the auxiliary processing unit 106. The auxiliary processing unit 106 may install and run the processing codes to perform the corresponding auxiliary processing tasks pertaining to the respective applications. The components of the computing system 100 are described in detail in conjunction with FIG. 2.

FIG. 2 illustrates various example components of the computing system 100 of FIG. 1 The computing system 100 includes the processor 102, which may be a main processing unit. In an example, some of the processing tasks that otherwise would have been performed by the processor 102 are offloaded to the auxiliary processing unit 106.

Further, the computing system 100 includes interface(s) 202, memory 204, the modules 104, and data 206. The interfaces 202 may include a variety of commercially available interfaces, for example, interfaces for peripheral device(s), such as data input output devices, referred to as I/O devices, interface cards, storage devices, and network devices.

The memory 204 may be communicatively coupled to the processor 102 and may include any non-transitory computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

The modules 104 may include a monitoring module 208, the auxiliary task module 110, application(s) 216, and other module(s) 210. The other modules 210 may include programs or coded instructions that supplement applications and functions, for example, programs in an operating system of the computing system 100. Further, the data 206 may include offloading determination data 212, code data 214, and other data 218. In an example, the applications 216 may be network based applications and may communicate with other device 220-1, 220-2 . . . 220-n, such as servers, data storage devices, and other computing devices over a network 222.

The network 222 may be a wireless network, a wired network, or a combination thereof. The network 222 can also be an individual network or a collection of many such individual networks, interconnected with each other and functioning as a single large network, e.g., the internet or an intranet. The network 222 can include different types of networks, such as intranet, local area network (LAN), wide area network (WAN), the internet, and such. The network 222 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. The network 222 may also include individual networks, such as but not limited to. Global System for Communication (GSM) network, Universal Telecommunications System (UMTS) network, and Long Term Evolution (LTE) network. Further, the communication between the computing system 100, the devices 220, and other entities may take place based on the communication protocol compatible with the network 222.

Further, the computing system 100 may include a network enabled component, such as a NIC (not shown), that may facilitate exchange of data pockets received or sent by the applications 216 over the network 222. In one example, the auxiliary processing unit 106 may be provided on the network enabled component of the computing system 100.

In an example, the monitoring module 208 may monitor each of the applications 216 hosted by the computing system 100 to determine a corresponding activity status. The activity status may indicate whether an application 216 is active or inactive. The application 216 may be considered to be active if it is exchanging data packets with one or more other devices 220 over the network 222 and may require processing resources for data exchange. Accordingly, the monitoring module 208 may identify active applications from among the applications 216.

To facilitate data exchange, multiple processing tasks may be performed for each of the active applications. For example, for a memcached related application, the auxiliary processing tasks may include key-parsing, hashing, and routing of a data packet based on a hashed value. In another example, for a streaming application, the auxiliary processing tasks may include other conditional evaluations that may be performed on each data packet.

The auxiliary processing tasks to be performed for each of the applications 216 may be indicated by way of an application-task mapping stored in the code data 214. The application-task mapping may be generated by a user, based on attributes, such as dependency, parallel execution, and amount of processing resources utilized for performing a processing task. For example, the processing tasks, which may not be dependent on any other processing task, and may be executed in parallel to certain processing tasks being performed by the processor 102, may be identified as the processing tasks that can be offloaded to the auxiliary processing unit 108. In other examples, the auxiliary processing tasks may be defined automatically by the computing system 100 using the other modules 210.

In addition to the application-task mapping, the code data 214 may include a processing code for each of the auxiliary processing tasks. Referring to the examples mentioned above, for the memcached based application, a processing code for each of key parsing, hashing, and routing of a data packet may be included in the code data 214. Likewise, for the streaming application, the processing code for each of the conditional evaluation to be performed may be included in the code data 214.

Further, the auxiliary task module 110 may ascertain whether the auxiliary processing unit 106 is available for performing the auxiliary processing tasks, based on offloading rules. The offloading rules may be stored in the offloading determination data 212. In an example, the offloading rules may include a check to determine whether the NIC includes the auxiliary processing unit 106 or whether the auxiliary processing unit 106 is located in another device, which may enable communication with the network 222. For instance, there may be a case, where the NIC may not include the hardware implementing the auxiliary processing unit 106.

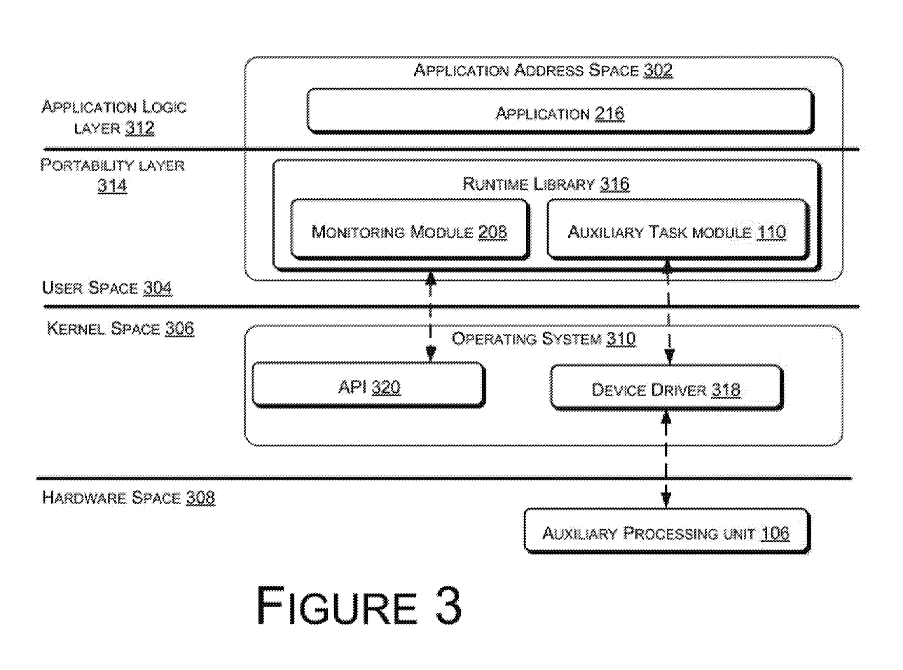

To ascertain the presence of the auxiliary processing unit 106, a device driver 318 (shown in FIG. 3) may be configured to communicate with the auxiliary task module 110. The functionality of the device driver 318 and the interaction of the device driver 318 with other components have been explained in detail with reference description of FIG. 3.

The device driver 318 may provide information pertaining to the presence of the auxiliary processing unit 106 and if present, the information pertaining to processing capabilities of the auxiliary processing unit 106. In another example, the availability may be based on the current processing load on the auxiliary processing unit 106. The auxiliary task module 110 may determine the processing load based on a number of processing tasks already assigned to the auxiliary processing unit 106 and average execution time for each of the offloaded processing tasks.

Based on the information provided by the device driver 318 and the processing load, if it is ascertained that the auxiliary processing unit 106 is not available, the processing code pertaining to determined auxiliary processing tasks may be provided to the processor 102. Accordingly, the processor 102 may process these tasks.

However, in case the auxiliary processing unit 106 is available, the auxiliary tasks may be offloaded to the auxiliary processing unit 106. Further, it will be understood that some or all of the auxiliary processing tasks pertaining to an application 216 may be offloaded to the auxiliary processing unit 106, based on the processing load on the auxiliary processing unit 106. To offload the auxiliary processing tasks, the auxiliary task module 110 may provide the processing code for each of the auxiliary processing tasks to a processing module 224 of the auxiliary processing unit 106. The processing module 224 may store the received processing codes in the auxiliary data 226. Further, the processing module 224 may process the data packets pertaining to the application 216, based on the auxiliary data 226. Thus, certain processing tasks that may otherwise be performed by the processor 102 may now be performed by the auxiliary processing unit 106, thereby reducing processing load on the processor 102.

Further, the auxiliary task module 110 may provide an uninstall trigger to the processing module 224 to uninstall one or more stored processing codes. The uninstall trigger may be provided based on code uninstallation criteria. The code uninstallation criteria may be stored in the offloading determination data 212. The code uninstallation criteria may include a check to determine one or more requirements which an installed processing code may fulfill. In an example, the uninstall trigger may be provided when a previously active application is no longer active. As mentioned before, the monitoring module 208 may monitor the applications 216 and on determining that the activity status of a previously active application has now become inactive, the monitoring module 208 may provide an update to the auxiliary task module 110. The auxiliary task module 110 may accordingly identify the offloaded auxiliary processing tasks corresponding to the previously active application. Further, in another example, the auxiliary task module 110, for each active application, may identify the offloaded auxiliary processing tasks that have been executed and may no longer be performed. Thus, the code uninstallation criteria may be based on an activity status of an application and/or usability of an already installed code for an active application.

The auxiliary task module 110 may ascertain if the code uninstallation is satisfied and may provide an uninstallation trigger accordingly. Thus, the uninstallation trigger may be based on a determination whether an installed processing code is to be executed to facilitate data exchange or can be uninstaller otherwise. The uninstall trigger may indicate to the processing module 224 to delete processing codes corresponding to the identified auxiliary processing tasks from the auxiliary data 226. Likewise, on determining that a previously inactive application has now become active, the auxiliary task module 110 may provide corresponding processing codes to the processing module 224 based on availability of the auxiliary processing unit 106. This way, the auxiliary processing unit 106 may be shared among multiple applications, which may provide for better utilization of resources.

Referring to the processing codes for the auxiliary processing tasks, in an example, a processing code for routing of data packets may include a logic to analyze content of the data packet to facilitate application aware routing of the data packets. In said example, the processing module 224, based on the core identification rules defined by a corresponding processing code, may analyze the content of the data packet and route the data packet to a corresponding core of the processor 102. Similarly, an outgoing data packet may be routed to another device 220. Thus, based on the core identification rules, a target processing unit for a data packet may be identified. In case of an incoming data packet, the target processing unit may be a core of the processor 102, and in case of an outgoing data packet, the target processing unit may be one of the devices 220.

In an example, for a memcached application, a data packet may include a key for which a server may have to respond with a value. In said example, the core identification rules may include analysis of the key included in the data packet to route the data packet to a corresponding core In another example, for a security application, the data packet may include application log information, in said example, the processing module 224 may perform a pattern match on the application log information and then inform the security application whether the data packet is a security threat.

FIG. 3 schematically illustrates an example architecture of the computing system 100 to perform the auxiliary processing tasks. As illustrated, the computing system 100 may include an application address space 302, a user space 304, a kernel space 306, and a hardware space 308.

The processor 102 may switch between the user space 304 and the kernel space 306, based on a type of application running on the processor 102. For example, the user space 304 may be used by a user to run the applications 216. Further, certain core components of an operating system 310 may run in kernel space 306. The application address space 302 may refer to a private virtual address space provided for each application 216 running on the computing system 100.

In an example, the application address space 302 may extend over an application logic layer 312 and a portability layer 314. The application logic layer 312 may include application logic and allows the application 216 to run or execute within the application logic layer 312. The portability layer 314 provides abstraction between the higher layers and the hardware space 308. The portability layer 314 includes a runtime library 316, which may be invoked at runtime. The runtime library 316 is generally a collection of utility functions that support a program while it is running.

In an example, the runtime library 316 provides an environment for the execution of the monitoring module 208 and the auxiliary task module 110. During execution various data, such as the offloading determination data 212 and the code data 214 may be made available to the monitoring module 208 and the auxiliary task module 110. As mentioned before, to share the processing load of the processor 102, some of the processing tasks performed by the processor 102 may be offloaded to the auxiliary processing unit 106.

In operation, the auxiliary processing tasks pertaining to the active applications may be offloaded. In an example, the monitoring module 208 may identify the active applications. The auxiliary task module 110 may ascertain the availability of the auxiliary processing unit 106, based on the offloading determination data 212. The information pertaining to availability of the auxiliary processing unit 106 may be gathered using a corresponding device driver 318. The device driver 318 facilitates communication between the components of the portability layer 314 and the auxiliary processing unit 106.

Based on the availability of the auxiliary processing unit 106, the processing codes, of the tasks to be offloaded, may be determined using the code data 214. The tasks to be offloaded may be provided to the auxiliary processing unit 106 through the corresponding device driver 318. The auxiliary processing unit 106 may store the received processing codes and perform the corresponding tasks.

However, in case it is ascertained the auxiliary processing unit 106 is not available, the auxiliary task module 110 may provide the determined processing tasks to the processor 102 through an API 320. In this way, the application 216 may be agnostic to the availability of the auxiliary processing unit 106 as it may be provided with output in the same way in either case.

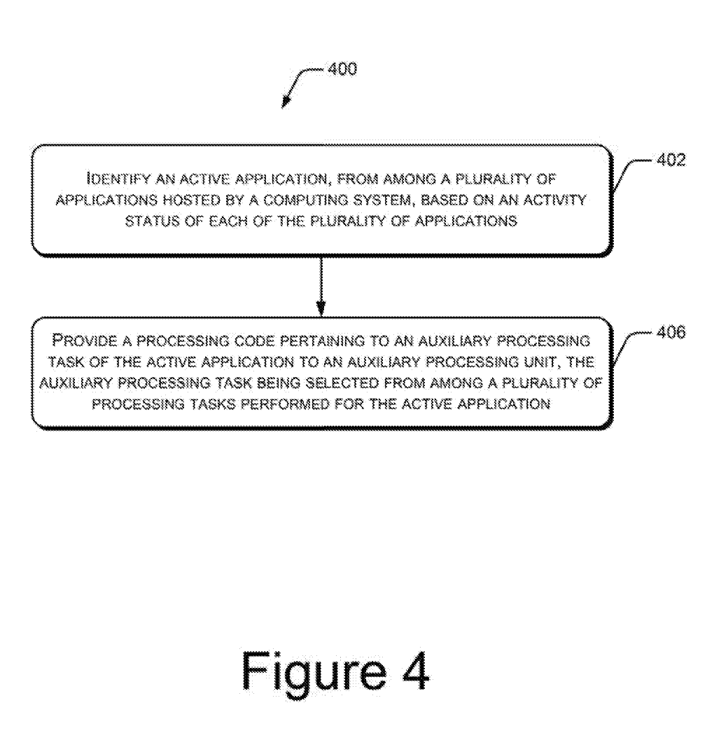

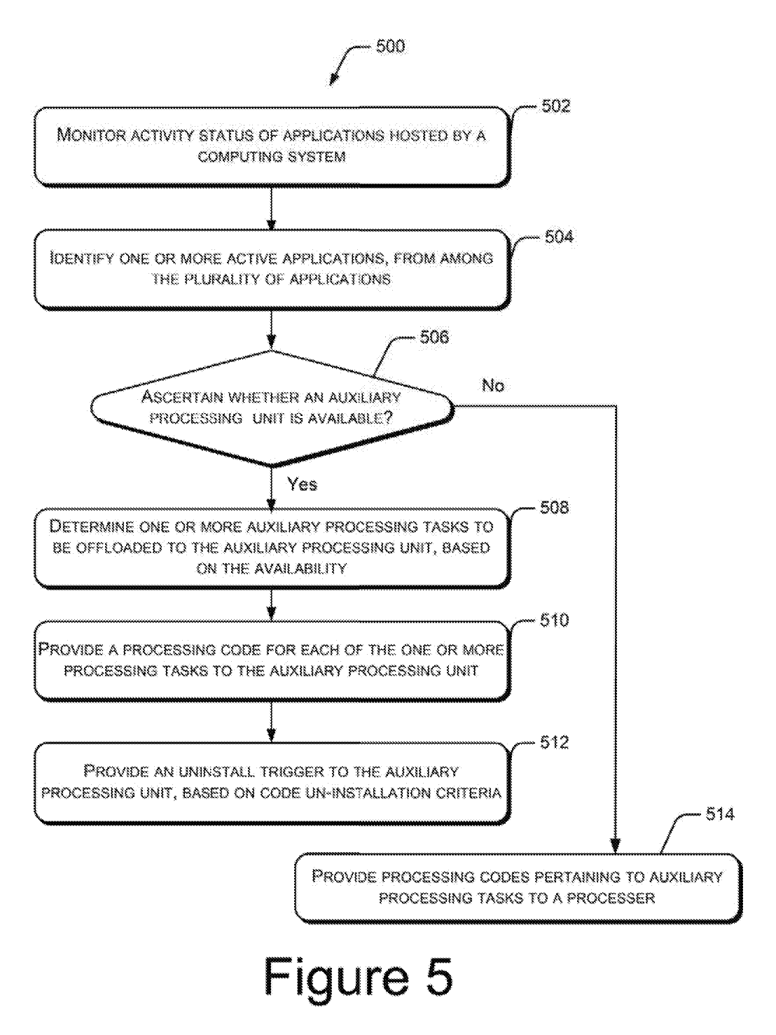

FIG. 4 illustrates an example method 400 for performing processing tasks using an auxiliary processing unit and FIG. 5 illustrates another example method 500 to perform processing tasks using an auxiliary processing unit.

The order in which the methods 400 and 500 are described is not intended to be construed as a limitation, and any number of the described method blocks can be combined in any order to implement the methods 400 and 500 or an alternative method. Additionally, individual blocks may be deleted from the methods 400 and 500 without departing from the spirit and scope of the subject matter described herein. Furthermore, the methods 400 and 500 can be implemented in any suitable hardware, software, firmware, or combination thereof.

It is appreciated that the methods 400 and 500 can be performed by programmed computing devices, for example, based on instructions retrieved from non-transitory computer readable media. The computer readable media can include machine-executable or computer-executable instructions to perform a whole or a part of the described method. The computer readable media may be, for example, digital memories, magnetic storage media, such as a magnetic disks and magnetic tapes, hard drives, or optically readable data storage media.

Referring to FIG. 4, the method 400 may be performed by a computing system, such as the computing system 100.

At block 402, an active application, from among a plurality of applications hosted by a computing system, is identified. The active application may be identified, based on an activity status of each of the plurality of the applications. In an example, the monitoring module 238 may identify the active application.

At block 404, a processing code pertaining to an auxiliary processing task of the active application is provided to an auxiliary processing unit. The auxiliary processing task may be from among a plurality of processing tasks performed for the active application. In an example, the auxiliary task module 110 may provide the processing code to the auxiliary processing unit 106.

Referring to FIG. 5, an activity status of a plurality of applications hosted by a computing system, such as the computing system 100, is monitored at block 502. In an example, the monitoring module 208 may monitor the activity status.

At block 504, one or more active applications, from among the plurality of applications may be identified, based on the monitoring. In an example, the monitoring module 208 may identify the active applications.

At block 506, it is ascertained whether an auxiliary processing unit such as the auxiliary processing unit 106 is available to perform auxiliary processing tasks pertaining to the active applications. In an example, the availability of the auxiliary processing unit 106 may be ascertained based on offloading rules. Further, the availability of the auxiliary processing unit 106 may be ascertained, for example, by the auxiliary task module 110. If at block 506, it is ascertained that the auxiliary processing unit 106 is available, the method 500 may proceed to (‘Yes’ branch) block 508.

At block 508, one or more auxiliary processing tasks to be offloaded to the auxiliary processing unit 106 may be determined, based on the availability of the auxiliary processing unit 106 and an application-task mapping. For example, based on the availability, the auxiliary processing tasks of all the active applications may be determined. In another example, the auxiliary processing tasks for a few active applications or a few auxiliary process tasks for a single application may be determined.

At block 510, a processing code for each of the one or more processing tasks may be provided to the auxiliary processing unit 106. The auxiliary processing unit 106 may accordingly process the data packets pertaining to one or more active applications hosted by the computing system 100. In an example, the auxiliary task module 110 may determine and provide the processing codes to the auxiliary processing unit 106.

At block 512, an uninstall trigger is provided to the auxiliary processing unit 106 to uninstall one or more of the installed processing codes, based on code uninstallation criteria The code installation criteria may be based on at least one of an activity status of an application for which the processing codes were earlier installed and a requirement of an installed processing code. In an example, the auxiliary task module 110 may provide the uninstall trigger.

However, if at block 506 it is ascertained that auxiliary processing unit 106 is not available, the method 500 may branch to (‘No’ branch) block 514.

At block 514, the auxiliary processing codes for the active applications are provided to a processor, such as the processor 102, of the computing system 100.

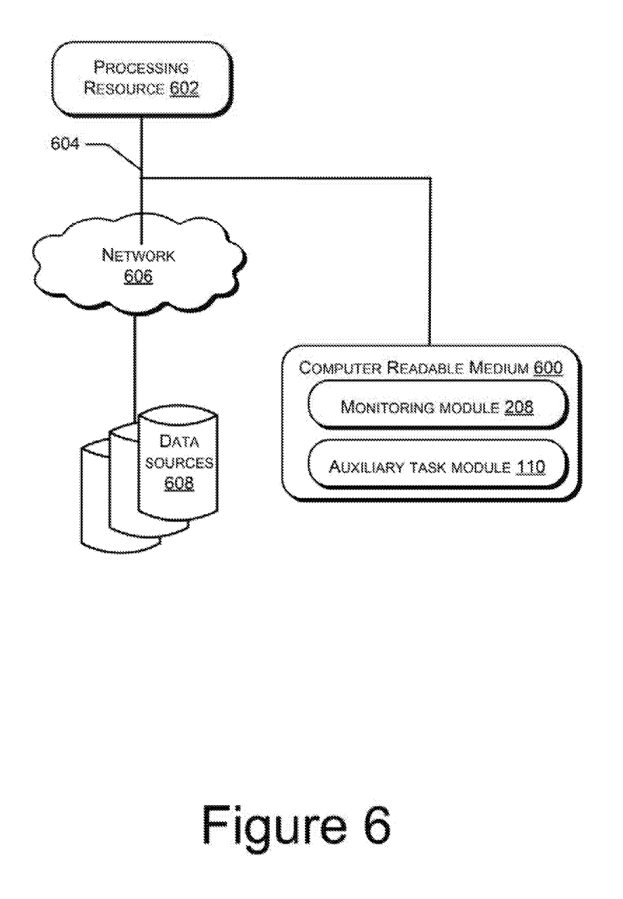

FIG. 6 illustrates an example computer readable medium 600 storing instructions for performing auxiliary processing tasks. In one example, the computer readable medium 600 is communicatively coupled to a processing resource 602 over a communication ink 604.

For example, the processing resource 602 can be a computing device, such as a server, a laptop, a desktop, a mobile device, and the like. The computer readable medium 600 can be, for example, an internal memory device or an external memory device or any commercially available non-transitory computer readable medium. In one example, the communication link 604 may be a direct communication link, such as any memory read/write interface. In another implementation, the communication link 604 may be an indirect communication link, such as a network interface. In such a case, the processing resource 602 can access the computer readable medium 600 through a network 606. The network 606 may be a single network or a combination of multiple networks and may use a variety of different communication protocols. In an example, the network 606 may be similar to the network 222.

The processing resource 602 and the computer readable medium 600 may also be communicatively coupled to data sources 608 over the network. The data sources 608 can include, for example, databases and computing devices. The data sources 608 may be used by the requesters and the agents to communicate with the processing unit 602.

In one implementation, the computer readable medium 600 includes a set of computer readable instructions, such as the monitoring module 208 and the auxiliary task module 110. The set of computer readable instructions can be accessed by the processing resource 602 through the communication link 604 and subsequently executed to perform acts for performing auxiliary processing tasks using the auxiliary processing unit 106.

On execution by the processing resource 602, the monitoring module 208 may identify an active application, from among a plurality of applications, based on an activity status of each of the plurality of applications. Further, the auxiliary task module 110 may determine a processing code, based on an application-task mapping, for each of one or more auxiliary processing tasks corresponding to the active application. The auxiliary processing tasks may be from among a plurality of processing tasks that may be performed for the active application. Further, the auxiliary task module 110 may provide the processing code corresponding to each of the one or more auxiliary processing tasks to the auxiliary processing unit 106. The auxiliary processing unit 106 may execute the processing codes to perform corresponding auxiliary processing task, thereby sharing processing load with the processor 102.

Although implementations for performing auxiliary processing tasks using an auxiliary processing unit have been described in language specific to structural features and/or methods, it is to be understood that the appended claims are not necessarily limited to the specific features or methods described. Rather, the specific features and methods are disclosed as example implementations for performing auxiliary processing tasks using an auxiliary processing unit.

I/We claim:

1. A computing system comprising:
a processor to perform a plurality of processing tasks for each of a plurality of applications hosted by the computing system;
an auxiliary processing unit coupled to the processor: and
an auxiliary task module coupled to the processor to:
determine an auxiliary processing task from the plurality of processing tasks for an active application from the plurality of applications: and
provide a processing code corresponding to the auxiliary processing task to the auxiliary processing unit, wherein the auxiliary processing unit executes the processing code to perform the auxiliary processing task.

2. The computing system as claimed in claim 1, wherein the auxiliary processing unit routes a data packet pertaining to the active application to a core from among a plurality of cores of the processor, based on core identification rules provided in the processing code.

3. The computing system as claimed in claim 1, wherein the auxiliary processing unit is implemented within a network interface card.

4. The computing system as claimed in claim 1, wherein the auxiliary task module further:
ascertains whether the auxiliary processing unit is available, based on offloading rules; and
identifies, based on the offloading rules, the auxiliary processing task to be offloaded to the auxiliary processing unit, when it is ascertained that the auxiliary processing unit is available.

5. The computing system as claimed in claim 1, wherein the computing system further comprises a monitoring module coupled to the processor to identify the active application from among the plurality of applications, based on an activity status of each of the plurality of applications.

6. The computing system as claimed in claim 1, wherein the auxiliary task module provides an uninstall trigger to the auxiliary processing unit to uninstall the processing code installed on the auxiliary processing unit, based on code uninstallation criteria.

7. A computer implemented method for performing processing tasks using an auxiliary processing unit, the method comprising:
identifying an active application from among a plurality of applications hosted by a computing system, based on an activity status of each of the plurality of applications; and
providing a processing code pertaining to an auxiliary processing task of the active application to the auxiliary processing unit, wherein the auxiliary processing task is from among a plurality of processing tasks performed for the active application.

8. The method as claimed in claim 7, wherein the method further comprises determining the auxiliary processing task pertaining to the active application based on an application-task mapping.

9. The method as claimed in claim 7, wherein the method further comprises:
receiving the processing code pertaining to the auxiliary processing task;
performing the auxiliary processing task on a data packet pertaining to the active application; and
providing the data packet to a target processing unit, based on an analysis of content of the data packet.

10. The method as claimed in claim 7, wherein the method further comprises:
ascertaining whether the auxiliary processing unit is available, based on offloading rules; and
providing, based on the offloading rules, the processing code pertaining to the auxiliary processing task to the auxiliary processing unit, when the auxiliary processing unit is available.

11. The method as claimed in claim 7, wherein the method further comprises providing a uninstall trigger to the auxiliary processing unit to uninstall the processing code installed on the auxiliary processing unit, based on code uninstallation criteria

12. A non-transitory computer-readable medium comprising instructions executable by a computing system to perform processing tasks using an auxiliary processing unit, wherein the non-transitory computer-readable medium comprises instructions to:
identify an active application from among a plurality of applications based on an activity status of each of the plurality of applications;
determine a processing code for an auxiliary processing task corresponding to the active application, wherein the auxiliary processing task is selected from among a plurality of processing tasks performed for the active application; and
provide the processing code corresponding to the auxiliary processing task to the auxiliary processing unit, wherein upon executing the processing code the auxiliary processing unit performs the auxiliary processing task and shares a processing load with the processor (102).

13. The non-transitory computer-readable medium as claimed in claim 12. wherein the non-transitory computer-readable medium comprises instructions executable by the computing system to:
ascertain whether the auxiliary processing unit is available, based on offloading rules; and
identify, based on the offloading rules, the auxiliary processing task to be offloaded to the auxiliary processing unit, when it is ascertained that the auxiliary processing unit is available.

14. The non-transitory computer-readable medium as claimed in claim 12, wherein the non-transitory computer-readable medium comprises instructions executable by the computing system to provide an uninstall trigger to the auxiliary processing unit to uninstall the processing code installed on the auxiliary processing unit, based code uninstallation criteria.

15. The non-transitory computer-readable medium as claimed in claim 12, wherein the processing code comprises a logic to analyze content of a data packet of the active application to identify a core, from among a plurality of cores, of a processor of the computing system, based on core identification rules, and wherein the data packet is routed to the identified core for further processing.
